(19) United States
(12) Patent Application Publication
(10) Pub. No.: US 2024/0153481 A1
(43) Pub. Date: May 9, 2024

(54) AUDIO SIGNAL RENDERING METHOD AND APPARATUS, AND ELECTRONIC DEVICE

(71) Applicant: BEIJING ZITIAO NETWORK TECHNOLOGY CO., LTD., BEIJING (CN)

(72) Inventors: Junjie SHI, BEIJING (CN); Xuzhou YE, BEIJING (CN); Zhengpu ZHANG, BEIJING (CN); Chuanzeng HUANG, BEIJING (CN); Derong LIU, BEIJING (CN)

(21) Appl. No.: 18/400,081

(22) Filed: Dec. 29, 2023

Related U.S. Application Data
(63) Continuation of application No. PCT/CN2022/103312, filed on Jul. 1, 2022.

(30) Foreign Application Priority Data
Jul. 2, 2021 (WO) PCT/CN2021/104309

(51) Int. Cl. G10K 15/08

(52) U.S. Cl. CPC G10K 15/08

(57) ABSTRACT

The present disclosure relates to the field of audio signal processing, and to an audio signal rendering method and apparatus, and an electronic device. The rendering method includes: estimating a reverberation time of an audio signal on each time point among a plurality of time points; and performing rendering processing on the audio signal according to the reverberation time of the audio signal.

### CROSS-REFERENCE TO RELATED APPLICATIONS

The present disclosure is based on and claims priority of PCT/CN2021/104309, filed on Jul. 2, 2021, the disclosure of which is hereby incorporated into this disclosure by reference in its entirety.

### TECHNICAL FIELD

This disclosure relates to the technical field of audio signal processing, particularly to an audio signal rendering method, an audio signal rendering apparatus, a chip, a computer program, an electronic device, a computer program products, and a non-transitory computer-readable storage medium.

### BACKGROUND

Reverberation refers to the acoustic phenomenon where the sound continues to exist after the sound source stops producing sound. The reason for reverberation is due to the slow propagation speed of sound waves in the air, as well as the obstruction and reflection of sound waves by walls or surrounding obstacles during propagation.

In order to objectively evaluate reverberation, the ISO 3382-1 standard defines a series of objective evaluation indicators for the impulse response of a room. The duration of reverberation decay, also known as reverberation time, is an important indicator for measuring the reverberation of a room. Reverberation time is the time required for the reverberation in a room to decay by 60 dB, calculated by selecting different decay ranges for the reverberation.

### SUMMARY

According to some embodiments of the present disclosure, there is provided a method for estimating reverberation time, comprising: constructing a model of an objective function based on differences between a decay curve of an audio signal and a parametric function of a fitted curve of the decay curve at a plurality of historical time points, as well as weights corresponding to the plurality of historical time points, wherein weights corresponding to late time points are smaller than those corresponding to early time points; with a parameter of the parametric function of the fitted curve as a variable and an objective of minimizing the model of the objective function, solving the objective function and determining the fitted curve of the decay curve; estimating a reverberation time of the audio signal based on the fitted curve.

According to other embodiments of the present disclosure, there is provided an audio signal rendering method, comprising: determining a reverberation time of the audio signal using an estimation method in any of the above embodiments; rendering the audio signal based on the reverberation time of the audio signal.

According to other embodiments of the present disclosure, there is provided an audio signal rendering method, comprising: estimating the reverberation time of the audio signal at each of a plurality of time points; rendering the audio signal based on the reverberation time of the audio signal.

According to some embodiments of the present disclosure, there is provided an apparatus for estimating reverberation time, comprising: a construction unit for constructing a model of an objective function based on differences between a decay curve of an audio signal and a parametric function of a fitted curve of the decay curve at a plurality of historical time points, as well as weights corresponding to the plurality of historical time points, wherein the weights vary with time; a determination unit for solving the objective function with a parameter of the parametric function of the fitted curve as a variable and with an objective of minimizing the model of the objective function, and determining the fitted curve of the decay curve; an estimation unit for estimating a reverberation time of the audio signal based on the fitted curve.

According to still other embodiments of the present disclosure, there is provided an audio signal rendering apparatus, comprising: an apparatus for estimating reverberation time according to any of the above embodiments; a rendering unit for rendering the audio signal based on the reverberation time of the audio signal.

According to still other embodiments of the present disclosure, there is provided an audio signal rendering apparatus, comprising: an estimation apparatus for estimating the reverberation time of the audio signal at each of a plurality of time points; a rendering unit for rendering the audio signal based on the reverberation time of the audio signal.

According to further embodiments of the present disclosure, there is provided a chip, comprising: at least one processor, and an interface for providing computer executable instructions to the at least one processor, wherein the at least one processor is used to execute the computer executable instructions to implement the reverberation time estimation method or the audio signal rendering method according to any of the above embodiments.

According to further embodiments of the present disclosure, there is provided a computer program, comprising: instructions that, when executed by a processor, cause the processor to perform the reverberation time estimation method or the audio signal rendering method according to any of the above embodiments.

According to further embodiments of the present disclosure, there is provided an electronic device comprising: a memory; a processor coupled to the memory, the processor configured to, based on instructions stored in the memory, implement the reverberation time estimation method or the audio signal rendering method according to any of the above embodiments.

According to still further embodiments of the present disclosure, there is provided a computer readable storage medium having stored thereon a computer program that, when executed by a processor, implements the reverberation time estimation method or the audio signal rendering method according to any of the above embodiments.

According to still further embodiments of the present disclosure, there is provided a computer program product comprising instructions that, when executed by a processor, implement the reverberation time estimation method or the audio signal rendering method according to any of the above embodiments.

According to still further embodiments of the present disclosure, there is provided a computer program comprising instructions that, when executed by a processor, implement the reverberation time estimation method or the audio signal rendering method according to any of the above embodiments.

Other features and advantages of the present invention will become apparent from the following detailed description of exemplary embodiments of the present disclosure with reference to the accompanying drawings.

### BRIEF DESCRIPTION OF THE DRAWINGS

The accompanying drawings, which are comprised to provide a further understanding of the present disclosure and are incorporated in and constitute a part of this specification, illustrate embodiments of the invention, and together with the illustrative embodiments of the present application serve to explain the present disclosure, but are not limitation thereof. In the drawings:

FIG. 1 shows a schematic diagram of an audio signal processing procedure according to some embodiments of the present disclosure;

FIG. 2 shows schematic diagrams of different stages of sound wave propagation according to some embodiments of the present disclosure;

FIGS. 3a-3e show schematic diagrams of RIR curves according to some embodiments of the present disclosure;

FIG. 4a shows a flowchart of a reverberation time estimation method according to some embodiments of the present disclosure;

FIG. 4b shows a flowchart of an audio signal rendering method according to some embodiments of the present disclosure;

FIG. 4c shows a block diagram of a reverberation time estimation apparatus according to some embodiments of the present disclosure;

FIG. 4d shows a block diagram of an audio signal rendering apparatus according to some embodiments of the present disclosure;

FIG. 4e shows a block diagram of a rendering system according to some embodiments of the present disclosure;

FIG. 5 shows a block diagram of an electronic device according to some embodiments of the present disclosure;

FIG. 6 shows a block diagram of an electronic device according to other embodiments of the present disclosure;

FIG. 7 shows a block diagram of a chip according to some embodiments of the present disclosure.

### DETAILED DESCRIPTION

Below, a clear and complete description will be given for the technical solution of embodiments of the present disclosure with reference to the figures of the embodiments. Obviously, merely some embodiments of the present disclosure, rather than all embodiments thereof, are given herein. The following description of at least one exemplary embodiment is in fact merely illustrative and is in no way intended as a limitation to the invention, its application or use. All other embodiments obtained by persons of ordinary skill in the art based on the embodiments of the present disclosure without creative efforts shall fall within the protection scope of the present disclosure.

Unless otherwise specified, the relative arrangement, numerical expressions and values of the components and steps set forth in these examples do not limit the scope of the invention. At the same time, it should be understood that, for ease of description, the dimensions of the various parts shown in the drawings are not drawn to actual proportions. Techniques, methods, and apparatus known to those of ordinary skill in the relevant art may not be discussed in detail, but where appropriate, these techniques, methods, and apparatuses should be considered as part of the specification. Of all the examples shown and discussed herein, any specific value should be construed as merely illustrative and not as a limitation. Thus, other examples of exemplary embodiments may have different values. Notice that, similar reference numerals and letters are denoted by the like in the accompanying drawings, and therefore, once an item is defined in a drawing, there is no need for further discussion in the accompanying drawings.

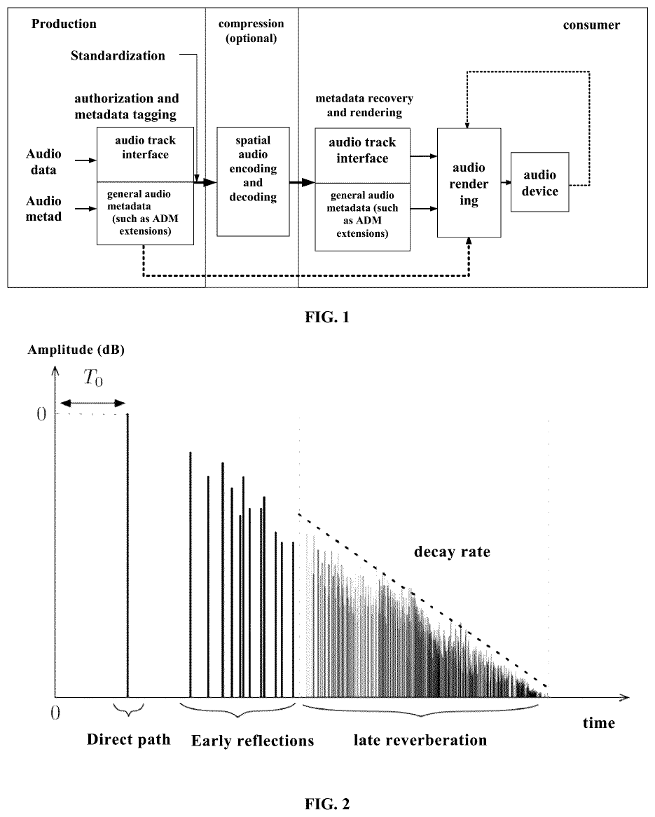

FIG. 1 shows a schematic diagram of an audio signal processing procedure according to some embodiments of the present disclosure.

As shown in FIG. 1, on the production side, authorization and metadata markup are carried out using audio track interfaces and general audio metadata (such as ADM extensions) based on audio data and audio source data. For example, standardization can also be carried out.

In some embodiments, spatial audio encoding and decoding for the processing results of the production side is performed to to obtain a compression result.

On the consumer side, based on the processing result (or compression result) of the production side, metadata recovery and rendering processing are carried out using audio track interfaces and general audio metadata (such as ADM extensions, etc.); the processing result is subjected to an audio rendering process and is then input to an audio device.

In some embodiments, the input of audio processing may comprise scene information and metadata, target-based audio signals, FOA (First Order Ambitonics), HOA (High Order Ambitonics), stereo, surround sound, etc; the input (output) of audio processing comprises a stereo audio output, etc.

FIG. 2 shows schematic diagrams of different stages of sound wave propagation according to some embodiments of the present disclosure.

As shown in FIG. 2, the procedure of sound waves propagation to people in the environment can be divided into three stages: direct path, early reflections, and late reverberation.

Taking the Room impulse response as a simple example, in the first stage, in response to a sound source being excited, a signal is transmitted from the sound source to a listener in a straight line, causing a delay of TO. This path is called the direct path. A direct path can provide a listener with information on the direction of sound.

After the direct path, there is an early reflection stage caused by reflections from nearby objects and walls. This part of reverberation presents the listener with geometric information and material information of space. Due to the multiple reflection paths, the density of the response in this part increases.

The energy of the signal continues to decay after the reflections, forming the tail of the reverberation, which is called late reverberation. This part has Gaussian statistical properties, and the power spectrum of this part also carries information such as the size of the environment and the absorption rate of the materials.

From audio signal processing, music production and mixing, to immersive applications such as virtual reality and augmented reality, reverberation is an important part of the audio experience. There are several technical solutions to present reverberation effects.

In some embodiments, the most direct way is to record a room impulse response in a real scene and later the convolve room impulse response with an audio signal to reproduce the reverberation. This recording method can achieve a more realistic effect, but due to the scene is fixed, there is no room for flexible adjustment later.

In some embodiments, reverberation can also be generated manually through algorithms. Artificial reverberation methods comprise parameterized reverberation and reverberation based on acoustic modeling.

For example, a parameterized reverberation generation method may be the FDN (Feedback Delay Networks) method. Parameterized reverberation usually has good real-time performance and low computational power requirements, but requires manual input of reverberation related parameters, such as reverberation time, ratio of direct sound intensity, etc. These types of parameters are usually not available directly from the scene and require manual selection and adjustment to achieve a matching effect with the target scene.

For example, reverberation based on acoustic modeling is more accurate and the room impulse response in a scene can be calculated based on scene information. In addition, reverberation based on acoustic modeling is highly flexible and can reproduce reverberation at any location in any scene.

However, the disadvantage of acoustic modeling is the computational cost. Acoustic modeling often requires more calculations to achieve good effects. The reverberation based on acoustic modeling has been greatly optimized in the development process, and with the advancement of hardware computing power, the requirements of real-time processing can be met gradually.

For example, in a case where computing resources are limited, the Room Impulse Response (RIR) can be pre-calculated through acoustic modeling, and the parameters required for parameterized reverberation can be obtained from the RIR to enable reverberation calculation in real-time applications.

In some embodiments, acoustic modeling (e.g., room acoustic modeling, environmental acoustic modeling, etc.) may be performed on the environment to provide a more realistic and immersive auditory experience.

Acoustic modeling can be applied to the field of architecture. For example, in the design of concert halls, movie theaters, and performance venues, acoustic modeling before construction can ensure that the building has good acoustic characteristics to achieve good auditory effects; In other scenarios, such as classrooms, subway stations, and other public places, acoustic modeling can also be used for auditory design to ensure that the acoustic conditions of the environment can meet the design expectations.

With the development of virtual reality, games, and immersive applications, in addition to the need for acoustic modeling in the construction of real-world scenes, there is also a need for environmental acoustic modeling in digital applications. For example, in different game scenes, in order to present the sound matching the current scene to the user, it is necessary to perform environmental acoustic modeling on the game scene.

In some embodiments, different frameworks have evolved for environmental acoustic modeling to adapt to different scenarios. There are two main categories in principle: Wave-based modeling, which obtains analytical solutions to wave equations based on sound wave characteristics for modeling; Geometric acoustics (GA): the estimation modeling is carried out by assuming the sound to a ray based on the geometric properties of the environment.

For example, wave-based modeling can provide the most accurate results by following the physical properties of sound waves. The computational complexity of this method is usually very high.

For example, although GA modeling is not as accurate as wave-based modeling, the speed of GA modeling is much faster. In GA modeling, the wave characteristics of sound are ignored, and the sound propagation in the air is assumed to be equivalent to the ray propagation. This assumption is applicable to high-frequency sound. However, estimation errors may be introduced for low-frequency sound because the propagation of low-frequency sound is dominated by wave characteristics.

In some embodiments, the RIR can be obtained through calculation by acoustic modeling. This allows acoustic modeling to be independent of physical space, increasing application flexibility. In addition, the acoustic modeling method avoids some of the problems associated with physical measurements, such as the influence of ambient noise, the need to measure in different positions and directions, etc.

In some embodiments, the method of GA modeling is derived from the following acoustic rendering equation:

$$l ( {x}^{′} , Ω ) = {l}_{0} ( {x}^{′} , Ω ) + {\int }_{G} R ( x , {x}^{′} , Ω ) l ( x , \frac{{x}^{′} - x}{\vert {x}^{′} - x \vert} ) dx$$

G in the equation is a set of points on the sphere around point x′. l(x′,Ω) is the time-dependent acoustic radiance emitted from point x′ in the direction of Ω. l₀(x′,Ω) is the sound energy emitted from point x′, and R is a bidirectional reflection distribution function (BRDF), which is an operator of the sound energy reflected in the Ω direction of the sound from point x to point x′, determines the type of reflection and describes the acoustic material of the plane.

In some embodiments, the GA modeling methods may comprise an image source method, a ray tracing method, etc. The image source method can only find the path of image emission. Ray tracing overcomes this problem by being able to find the path of any reflection type, comprising diffuse reflection.

For example, the basic idea of ray tracing is to emit rays from a sound source reflected in a scene, and find a feasible path from the sound source to a listener.

For each emitted ray, a ray is first emitted in a direction chosen randomly or according to a preset distribution. If the sound source has directionality, the energy carried by the emitted ray is weighted based on the direction of the emitted ray.

Then, the ray propagates in its direction. A reflection occurs when the ray collides with a scene. Based on the acoustic material at the collision site, the ray has a new emission direction and propagates continuously according to the new emission direction.

If the ray hits the listener as it propagates, that path is recorded. With the propagation and reflection of the ray, the propagation of the ray can be terminated when it reaches a certain condition.

For example, there may be two conditions for determining the termination of ray propagation.

One condition is that each time the ray is reflected, a portion of the ray's energy is absorbed by the material of the scene; During the propagation of the ray, as the distance increases, the propagation medium (such as air) also absorbs the ray's energy; if the energy carried by the ray continues to decay and reaches a certain threshold, the propagation of the ray stops.

Another condition is “Russian Roulette”. In this condition, there is a certain probability that a ray may be terminated at each reflection. This probability is determined by the absorption rate of the material. Because a material often has different absorption rates for sound in different frequency bands, this condition is less common in acoustic ray tracing applications.

In addition, because the early stage of reverberation is usually more important than the late stage, and because of computational considerations, a maximum number of reflections can be set in practical applications. If the number of reflections of a ray in a scene exceeds the specified value, the reflection of the ray stops.

With a certain number of rays emitted, a number of paths from the sound source to the listener can be obtained. For each path, the energy carried by the ray along that path may be known. Based on the length of the path and the speed of sound in the medium, the time t for propagation in the path may be calculated, obtaining an energy response Eₙ (t). The RIR of the sound source for the listener in this scene can be represented as:

p(t)=Σ_{n=N}aₚ\sqrt{Eₙ(t)}

aₚ is a weight value related to the total number of emitted rays, t is time, Eₙ (t) is the response energy intensity of the path, n is the number of the nth path, and N is the total number of paths. In computer calculations, p(t) can be a discrete value.

In some embodiments, according to the different decay ranges, the decay time can be divided into EDT (early decay time), T₂₀, T₃₀, and T₆₀, all of which belong to the reverberation time.

EDT represents the time required for a decay from 0B to −10 dB, the time required for reverberation decay by 60 dB may be calculated. T₂₀ and T₃₀ represent the time required for a decay from −5 dB to −25 dB and −35 dB, respectively, which can also be used to estimate the time required for a 60 dB decay. T60 represents the time required for a decay from 0 dB to −60 dB.

These indicators have a relatively high correlation within the same room. But they also show significant differences in certain room characteristics.

In some embodiments, other objective indicators of reverberation further comprise: sound strength, clarity measures, spatial impression, etc. As shown in Table 1:

| Indicator | | |
|---|---|---|
| Type | Indicators | Notes |
| Decay Time | T₆₀ | Physically important |
| sound | EDT | Subjectively |
| strength | | important |
| clarity | G, strength | the impact of the |
| measures | D₆₀, definition | hall on the sound |
| | C₅₀, clarity | level |
| | C₈₀, clarity | the clarity of |
| | Ts, central time | speech |
| | | the clarity of music |
| Spatial | LF_{early}, early lateral | significant source |
| impression | energy fraction, | width |
| | IACC_{early}, early hall sound | audience surrounding |
| | quality parameter | |
| | GLL, late lateral sound | |
| | level | |

Reverberation time is an important indicator used to evaluate the acoustic perception of reverberation in a room, and it is also a necessary parameter for generating reverberation with an artificial reverberation method. In real-time applications, to conserve real-time computing resources, reverberation results obtained by geometric acoustic modeling can be used in the pre-processing stage to calculate a room reverberation time, and artificial reverberation can be calculated using this parameter.

In some embodiments, the image source method and the ray tracing method can be combined to calculate reverberation in a room. For a direct path or a low order early reflection, the image source method can be used to find a path of sound from the listener to the mirrored sound source; a remaining energy intensity is calculated for a path based on the energy of the sound source, the length of the path, the energy absorbed by reflections from walls along the path, and the energy absorbed by the air; a time of the response generated by the path is obtained based on the length of the path and the speed of sound propagation in the air.

In addition, due to the different absorption rates of air and walls for different frequency bands of sound, the results obtained are stored separately for each frequency band.

For late reverberation, caused by more reflections and scattering, rays can be generated uniformly from the listener's location in all directions outward; when a ray hits an obstacle or wall, the next ray is emitted from the intersection based on the material properties; when the ray intersects with the sound source, a path from the listener to the sound source can be obtained, and the time and intensity of the response caused by that path can be determined.

If a ray is reflected by obstacles a certain number of times, or if the energy of the ray is below a certain threshold, the path can be terminated. By combining the results of all paths, a time-energy scatter plot is obtained, i.e., the RIR.

Compared to the room impulse response obtained from actual measurements, the calculation of room reverberation time from geometric acoustic simulation results has several advantages: a time point at which reverberation begins can accurately obtained; no post-processing, such as filtering, is required on the resultant room impulse response; the simulated RIR contains no noise.

The results obtained using the calculation method of the above embodiments also have these following advantages. the time at which the reverberation starts can be determined conveniently. In the RIR obtained from the acoustic simulation results, the first point in the time domain is the time at which the reverberation begins. The RIR is calculated separately for different frequency bands. To calculate the reverberation time of a particular frequency band, only the RIR of that frequency band is needed in the calculation, without the need for frequency division filtering operation; the calculated RIR comes entirely from the response brought by the path from the sound source to the listener, and there is no noise floor issue.

In some embodiments, a decay curve is first calculated based on RIR. The decay curve E(t) is a graphical representation of the variation of the room sound pressure with time after the sound source has ceased, which can be obtained by Schroeder's backward integration:

E(t)=∫ₜ^{∞}p²(z)dτ=∫_{∞}^{t}p²(T)d(−τ)

p(τ) is RIR, representing the variation of sound pressure at the measurement point over time. t is time, dτ is the differentiation over time. In practical computer applications, E(t) is represented by discrete values.

In the actual response obtained, RIR has a finite length and cannot be integrated to positive infinity. So theoretically, some of the energy is lost due to this truncation. Therefore, some compensation can be made to correct for the lost energy, one approach is to add a constant C to the decay curve.

E(t)=∫ₜ_{¹}^{t}p²(τ)d(−τ)+C,t<t₁

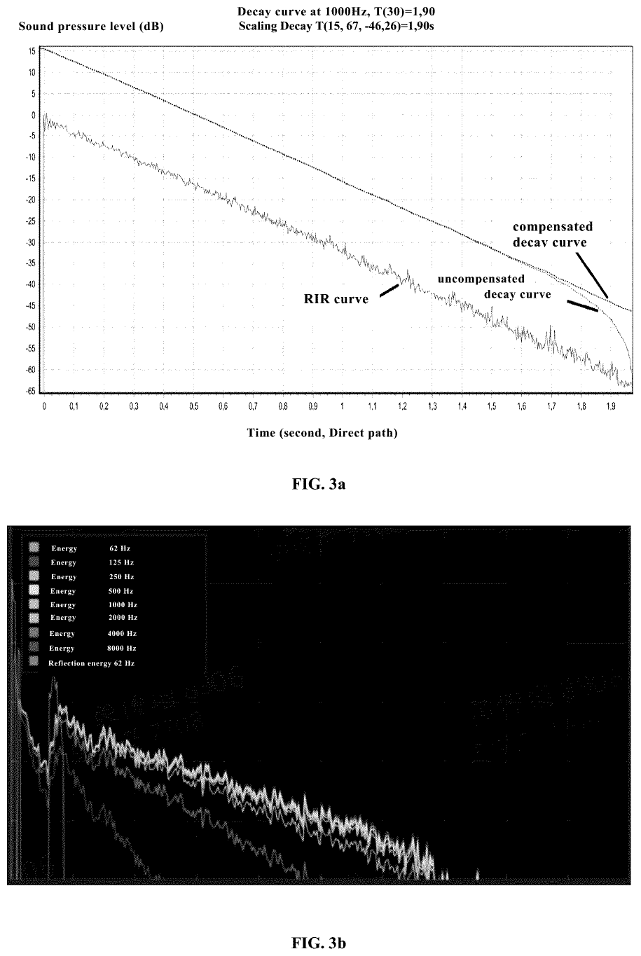

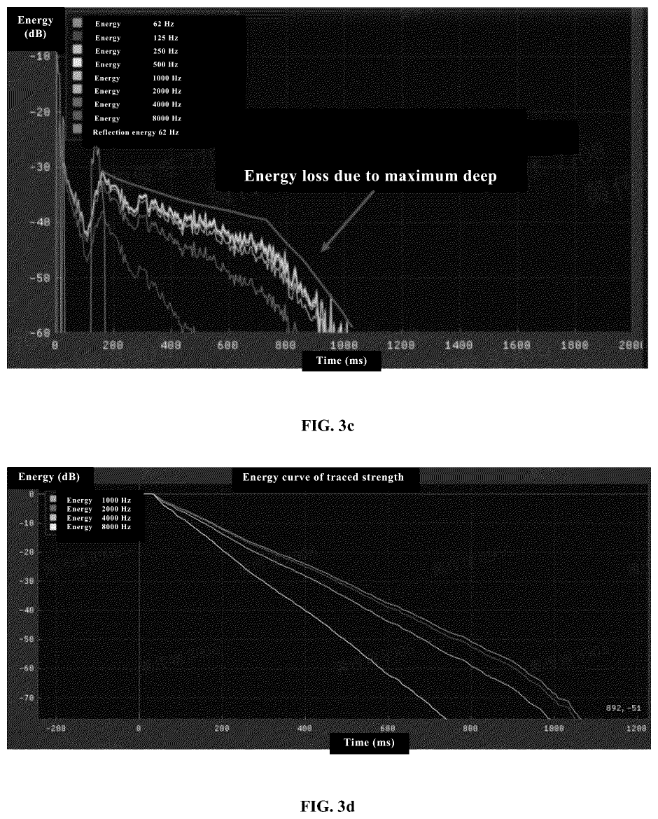

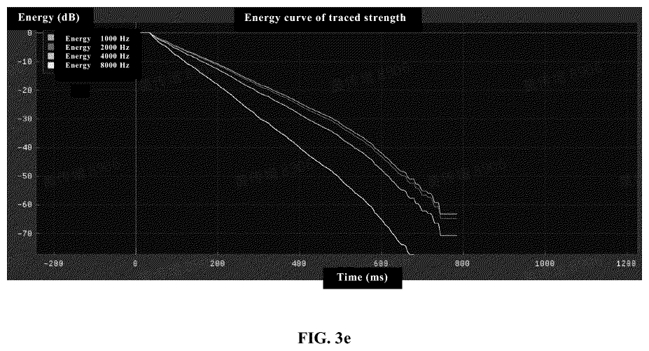

FIG. 3a shows a schematic diagram of a RIR curve according to some embodiments of the present disclosure.

FIG. 3a shows three curves: a RIR curve, an uncompensated decay curve, and a compensated decay curve.

After obtaining a decay curve, linear fitting can be used to fit a certain part of the decay curve to obtain the reverberation time. For T₂₀, a portion of the decay curve that decreases by 5 dB to 25 dB from a stable state is selected; For T₃₀, a portion of the decay curve that decreases by 5 dB to 35 dB from the stable state is selected; For T₆₀, a portion of the decay curve that decreases to 60 dB from the stable state is selected. The slope of a straight line used for fitting is calculated as the decay rate d, in dB per second, corresponding to a reverberation time of 60/d.

Particularly, for the obtained decay curve E(t), ƒ(x)=a+bx that minimizes R²=Σᵢ(E(tᵢ)−f(tᵢ))² is expected to be found, that is, R²=(a, b)=Σᵢ(E(tᵢ)−(a+btᵢ))² can get the minimum value. Thereby, the following expected conditions can be obtained:

$$\frac{\partial ( {R}^{2} )}{\partial a} = - 2 {\sum }_{i} ( E ( {t}_{i} ) - ( a + {bt}_{i} ) ) = 0 \\ \frac{\partial ( {R}^{2} )}{\partial b} = - 2 {\sum }_{i} ( E ( {t}_{i} ) - ( a + {bt}_{i} ) ) {t}_{i} = 0$$

and then:

na+bΣᵢ₌₁ⁿtᵢ=Σᵢ₌₁ⁿE(tᵢ)

aΣᵢ₌₁ⁿtᵢ+bΣᵢ₌₁ⁿtᵢ²=Σᵢ₌₁ⁿE(tᵢ)tᵢ
n is the total number of energy points in the decay curve. Thus,

$$b = \frac{cov ( t , E )}{{σ}_{t}^{2}} = \frac{{SS}_{t} , E}{{SS}_{tt}} \\ a = \overline{E} - b \overline{t}$$

cov is the covariance, σ is variance, Ē, t̅ represent the means of E and t, respectively.

SS_{t,t}=Σᵢ₌₁ⁿ(tᵢ−t̅ᵢ)²=(Σᵢ₌₁ⁿtᵢ²)−nt̅ᵢ²

SS_{t,E}=Σᵢ₌₁ⁿ(tᵢ−t̅ᵢ)(E(tᵢ)−Ē(tᵢ))=(Σᵢ₌₁ⁿtᵢE(tᵢ))−nt̅ᵢĒ(tᵢ)

In the linear fitting result of the decay curve, a is the desired slope, i.e. the decay rate. Then, the value of reverberation time can be obtained. Finally, the reverberation time of RT=−60/b is estimated using E(t).

In geometric acoustic modeling using ray tracing as a simulation method, for computational reasons, the number of ray reflections in the scene is often constrained, i.e., the number of ray reflections in the scene is truncated.

In the case of a longer reverberation time in a scene which the user locates, which causes an insufficient path depth that cannot cover the entire reverberation time, the truncation of the path depth causes some energy to be discarded, resulting in an accelerated decay of RIR energy at the tail, thereby presenting a shape similar to exponential decay.

FIGS. 3b and 3c show schematic diagrams of RIR curves according to some embodiments of the present disclosure.

As shown in FIG. 3b, for a reverberation curve of sufficient depth, the energy (dB) of the RIR decays linearly and can be accurately estimated by linear fitting.

The energy (dB) of the RIR should decay linearly. However, as shown in FIG. 3c, for a reverberation curve with insufficient depth, the loss of depth results in the loss of some energy, which accelerates the decay and makes it impossible to accurately estimate the corresponding decay curve by linear fitting. From the decay plot, it can be seen that truncation causes two problems:
1. The decay curve loses all energy at a time point earlier than the reverberation time;
2. The slope at the end of the decay curve is greater than the slope before the truncation, making the decay curve look like a curve with nonlinear characteristics.

FIGS. 3d and 3e show schematic diagrams of RIR curves according to some embodiments of the present disclosure.

As shown in FIGS. 3d and 3e, if the path depth is truncated, the RIR results in a smaller estimated reverberation time using the traditional linear fitting method. For real-time reverberation systems, setting inaccurate reverberation values for artificial reverberation methods can also affect the immersion of the playback system.

In some embodiments, the linear fitting method is improved for reverberation time estimation to address the issues caused by the path depth truncation mentioned above. With the improved method, the estimated reverberation time can be compensated based on the decay curve with energy loss.

Obtaining a decay curve E′(t) using ray tracing as a simulation method which aims at finding f(x)=a+bx to fit E′(t). However, due to the presence of depth truncation, E′(t) is not necessarily an accurate decay curve. It is desired that the slope of the fitted curve matches the ideal decay curve E(t) without depth truncation. Due to the characteristics of deep truncation, it can be assumed that if there is an energy loss caused by deep truncation, the error in the later stage of E′(t) may be greater than that in the earlier stage, and the earlier stage may be more reliable than the later stage.

In some embodiments, a method is provided for fitting a decay curve by a line with a minimizing objective by a time-domain weighted function, thereby obtaining the reverberation time.

Regarding the issue that E′(t) may not necessarily be accurate, on the basis of the objective of minimizing R²=Σᵢ(E′(tᵢ)−ƒ(tᵢ))² in linear fitting, E′(t) contributions at different times are weighted:

R_{new}²=Σᵢk(tᵢ)(E′(tᵢ)−ƒ(xᵢ))²=Σᵢk(tᵢ)(E′(tᵢ)−(a+btᵢ))²

E′(t) is the RIR decay curve obtained through simulation calculation, and f(x)=a+bx is a line used for fitting, k(tᵢ) is a weight that varies over time. It is desired to find the values of a and b to determine a line f(x) that can minimize R_{new}².

That is,

$$\frac{\partial ( {R}_{new}^{2} )}{\partial a} = - 2 {\sum }_{i} k ( {t}_{i} ) ( E ( {t}_{i} ) - ( a + {bt}_{i} ) ) = 0 \\ \frac{\partial ( {R}^{2} )}{\partial b} = - 2 {\sum }_{i} k ( {t}_{i} ) ( E ( {t}_{i} ) - ( a + {bt}_{i} ) ) {t}_{i} = 0$$

Thus, the following equations can be obtained:

$$na + b {\sum }_{i = 1}^{n} {t}_{i} = {\sum }_{i = 1}^{n} E ( {t}_{i} ) \\ a {\sum }_{i = 1}^{n} {t}_{i} + b {\sum }_{i = 1}^{n} {t}_{i}^{2} = {\sum }_{i = 1}^{n} E ( {t}_{i} ) {t}_{i} \\ then : \\ b = \frac{mean ( k ( t ) E ( t ) t ) - mean ( k ( t ) t ) \times mean ( k ( t ) E ( t ) )}{mean ( k ( t ) {t}^{2} ) - {mean ( k ( t ) t )}^{2}}$$

The mean( ) is the mean function. Finally, the reverberation time of RT=−60/b is estimated using E′(t).

In some embodiments, for the minimization objective, the decay curve can be weighted instead of weighting the square of the difference between the decay curve and the fitted line:

R_{new}²=Σᵢ(k(tᵢ)E′(tᵢ)−ƒ(xᵢ))²

Alternatively, a standard deviation can be used instead of the variance as the minimization objective. For example,

R_{new}=Σᵢk(tᵢ)E′(tᵢ)−ƒ(xᵢ))

R_{new}=Σᵢ(k(tᵢ)E′(tᵢ)−ƒ(xᵢ))

In some embodiments, for the selection of weight k(t), one solution is to make the weight decrease over time.

This design takes into account that the later part of the decay curve, the less accurate it is and the less weight it should be given.

By allowing the weight k(t) to decrease with time, it is possible to more accurately estimate the true reverberation time in a case where the energy decay curve obtained from the acoustic simulation is affected by path depth truncation. The estimated original reverberation time achieves a consistent estimation without being affected by truncation.

Considering that the energy of reverberation decreases over time, for example, the following formula can be used:

k(t)=a(E′(t)−min(E′(t)))^{b}/(mean(E′(t))+min(E′(t)))^{c}

The a, b and c are custom coefficients, which can be constants or coefficients obtained based on specific parameters. In the present disclosure, a coefficient can be added or removed before any term in the formula, or an offset can be added or removed for any term.

In some embodiments, a weight that is unrelated to E′ (t) may be used, for example: k(t)=ae^{-t}, wherein e is the natural logarithm, and a is an optional weight value, or k(t)=mt+n, wherein m and n are freely selected coefficients.

The different selection of weight k(t) may affect the effect of reverberation time compensation, so k(t) can be selected based on the characteristics of the audio signal.

In ray-tracing based rendering engines, a method for correcting errors in reverberation time estimation caused by insufficient ray path depth comprises the following steps.
1. Fitting a decay curve with a line with the minimizing objective by a time-domain weighted function to obtain the reverberation time.
2. For the selection of the weight, one solution is to make the weight decrease over time.

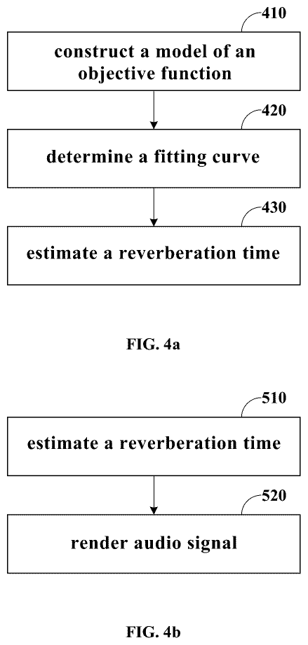

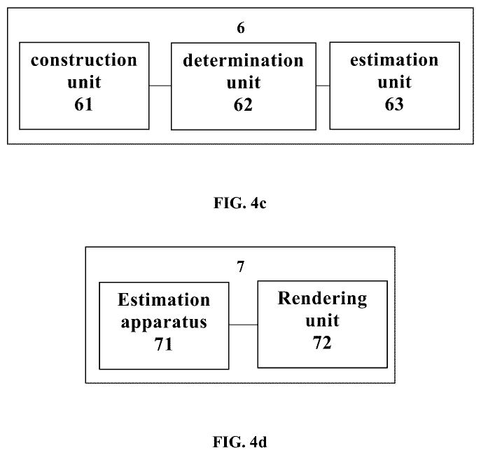

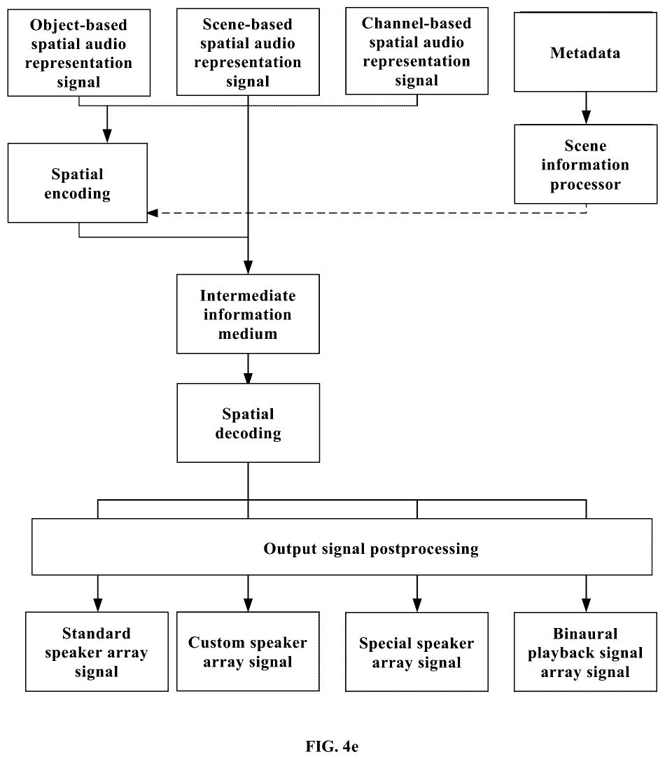

FIG. 4a shows a flowchart of a reverberation time estimation method according to some embodiments of the present disclosure.

As shown in FIG. 4a, in step 410, a model of an objective function is constructed based on differences between a decay curve of an audio signal and a parametric function of a fitted curve of the decay curve at a plurality of historical time points, as well as weights corresponding to the plurality of historical time points, wherein the weights vary with time.

For example, a weight corresponding to a later time point is smaller than a weight corresponding to an earlier time point. For example, the decay curve is determined based on the RIR of the audio signal.

In some embodiments, a weighted sum of the differences between the decay curve and the parametric function of the decay curve's fitted curve at a plurality of historical time points is calculated using weights corresponding to the plurality of historical time points. A model of an objective function is constructed based on a weighted sum of the differences between the decay curve and the parametric function of the decay curve's fitted curve at the plurality of historical time points.

For example, a weighted sum of variances or standard deviations between the decay curve and the parametric function of the decay curve's fitted curve at a plurality of historical time points is calculated using the weights corresponding to the plurality of historical time points.

In some embodiments, the decay curve is weighted at a plurality of historical time points using weights corresponding to the plurality of historical time points; a model of an objective function is constructed based on differences between the weighted decay curve and the parametric function of the decay curve's fitted curve at a plurality of historical time points.

For example, differences between the weighted decay curve and the parametric function of the decay curve's fitted curve at a plurality of historical time points are summed to construct a model of an objective function.

For example, a model of an objective function is constructed based on variances or standard deviations between the weighted decay curve and the parametric function of the decay curve's fitted curve at a plurality of historical time points.

For example, the variances or standard deviations between the weighted decay curve and the parametric function of the decay curve's fitted curve at a plurality of historical time points are summed to construct a model of an objective function.

In some embodiments, weights corresponding to the plurality of historical time points are determined based on the statistical characteristics of the function of the decay curve; a model of the objective function is constructed based on the weights corresponding to the plurality of historical time points.

For example, based on the minimum function value and average function value of the decay curve and the function values of the decay curve at a plurality of historical time points, the weights of the plurality of historical time points are determined.

For example, the weights of a plurality of historical time points are determined based on the differences between the function values of the decay curve at the plurality of historical time points and the minimum function value of the decay curve, and the sum of the minimum function value of the decay curve and the average function value of the decay curve, the weights of the plurality of historical time points being positively correlated with the differences and negatively correlated with the sum.

For example, the weights of a plurality of historical time points are determined based on the ratios of the differences at the plurality of historical time points to the sum.

In some embodiments, the weights corresponding to a plurality of historical time points are independent of the characteristic of the decay curve. For example, the weights of a plurality of historical time points are determined based on an exponential function or linear function which decreases over time; a model of an objective function is constructed based on the weights of the plurality of historical time points.

In some embodiments, weights corresponding to a plurality of historical time points are determined based on the characteristics of the sound signal; a model of the objective function is constructed based on the weights corresponding to the plurality of historical time points.

In step 420, with a parameter of the parametric function of the fitted curve as a variable and the objective of minimizing the model of the objective function, the objective function is solved to determine the fitted curve of the decay curve.

In some embodiments, a first extremum equation is determined based on a partial derivative of the objective function with respect to the slope coefficient of a linear function; a second extremum equation is determined based on a partial derivative of the objective function with respect to the intercept coefficient of the linear function; the first and second extremum equations are solved to determine the slope coefficient of the fitted curve.

In step 430, a reverberation time of the audio signal is estimated based on the fitted curve.

In some embodiments, the reverberation time is determined based on the slope coefficient of the linear function. For example, the reverberation time is proportional to the reciprocal of the slope coefficient of the linear function.

In some embodiments, the reverberation time is determined based on the slope coefficient of the linear function and a preset reverberation energy decay value. For example, the reverberation time is determined based on a ratio of the preset reverberation energy decay value to the slope coefficient. The preset reverberation energy decay value may be 60 dB.

FIG. 4b shows a flowchart of an audio signal rendering method according to some embodiments of the present disclosure.

As shown in FIG. 4b, in step 510, a reverberation time of the audio signal is estimated at each of a plurality of time points. For example, a reverberation time of the audio signal is determined using an estimation method described in any of the above embodiments.

In step 520, the audio signal is rendered based on the reverberation time of the audio signal.

In some embodiments, a reverberation is generated for the audio signal based on the reverberation time; the reverberation is added to a bitstream of the audio signal. For example, the reverberation is generated based on at least one of a type of an acoustic environment model or an estimated late reverberation gain.

For example, acoustic environment models may comprise physical reverberation, artificial reverberation, and sample reverberation, etc. Sample reverberation comprises sample reverberation in a concert hall, sample reverberation in a recording studio, etc.

In some embodiments, various reverberation parameters can be estimated using AcousticEnv( ) for adding the reverberation to a bitstream of the audio signal.

For example, AcousticEnv( ) is an extended static metadata acoustic environment, and the metadata decoding syntax is as follows.

```
AcousticEnv( ) {
  b_earlyReflectionGain
  b_lateReverbGain
  reverbType
  if (b_earlyReflectionGain == 1) {
    earlyReflectionGain
  }
  if (b_lateReverbGain == 1) {
      lateReverbGain
  }
  lowFreqProFlag
  if (reverbType == 2) {
    convolutionReverbType
  }
  numSurface
  numSurface = numSurface + 1
  for (i = 0; i < numSurface; i++) {
      Surface( )
  }
}
```

b_earlyReflectionGain consists of 1 bit for indicating whether the earlyReflectionGain field exists in AcousticEnv( ), which is ‘0’ indicating not existing and ‘1’ indicating existing. b_lateReverbGain consists of 1 bit for indicating whether the lateReverbGain field exists in AcousticEnv( ), which is ‘0’ indicating not existing and ‘1’ indicating existing. reverbType consists of 2 bits for indicating the type of the acoustic environment model, which is ‘0’ indicating “Physical (physical reverberation)”, ‘1’ indicating “Artificial (artificial reverberation)”, ‘2’ indicating “Sample (sample reverberation)” and ‘3’ indicating “extension type”. earlyReflectionGain consists of 7 bits for indicating the early reflection gain. lateReverbGain consists of 7 bits for indicating the late reflection gain. lowFreqProFlag consists of 1 bit for indicating the low-frequency separation processing, which is ‘0’ indicating Reverberation is not performed on low frequencies to maintain the definition. convolutionReverbType consists of 5 bits for indicating the sample reverberation type. The convolutionReverbType may be 0, 1, 2, . . . , and N. For example, ‘0’ indicates sample reverberation in a concert hall, and ‘1’ indicates sample reverberation in a recording studio. numSurface consists of 3 bits for indicating the number of surface( ) interfaces in acousticEnv( ). The numSurface may be 0, 1, 2, 3, 4 or 5. Surface( ) is an interface for decoding wall metadata of the same material.

In some embodiments, audio signal rendering can be performed by a rendering system shown in FIG. 4e as an embodiment.

FIG. 4e shows a block diagram of a rendering system according to some embodiments of the present disclosure.

As shown in FIG. 4e, the audio rendering system comprises a rendering metadata system and a core rendering system.

Control information that describes audio content and rendering techniques is present in the metadata system, indicating for example, whether the input mode of the audio payload is single-channel, dual-channel, multi-channel, Object or soundfield HOA, as well as location information of dynamic sound source and listener, rendering acoustic environment information (such as room shape, size, wall material, etc.).

The core rendering system renders on corresponding playback devices and environments based on different audio signal representations and corresponding metadata parsed by the metadata system.

FIG. 4c shows a block diagram of a reverberation time estimation apparatus according to some embodiments of the present disclosure.

As shown in FIG. 4c, the reverberation time estimation apparatus 6 comprises: a construction unit 61 for constructing a model of an objective function based on differences between a decay curve of an audio signal and a parametric function of a fitted curve of the decay curve at a plurality of historical time points, as well as weights corresponding to the plurality of historical time points, wherein the weights vary with time; a determination unit 62 for solving the objective function with the parameters of the parametric function of the fitted curve as variables, and with an objective of minimizing the model of the objective function, to determine the fitted curve of the decay curve; an estimation unit 63 for estimating a reverberation time of the audio signal based on the fitted curve.

For example, a weight corresponding to a later time point is smaller than a weight corresponding to an earlier time point. For example, the decay curve is determined based on the RIR of the audio signal.

In some embodiments, the construction unit 61 calculates a weighted sum of the differences between the decay curve and the parametric function of its fitted curve at a plurality of historical time points using weights corresponding to the plurality of historical time points; constructs a model of an objective function based on the weighted sum of the differences between the decay curve and the parametric function of its fitted curve at the plurality of historical time points.

For example, a weighted sum of the variances or standard deviations between the decay curve and the parametric function of its fitted curve at a plurality of historical time points is calculated using the weights corresponding to the plurality of historical time points.

In some embodiments, the construction unit 61 weights the decay curve at a plurality of historical time points using weights corresponding to the plurality of historical time points; constructs a model of an objective function based on differences between the weighted decay curve and the parametric function of its fitted curve at the plurality of historical time points.

For example, the construction unit 61 calculates a sum of the differences between the weighted decay curve and the parametric function of its fitted curve at the plurality of historical time points to construct a model of an objective function.

For example, the construction unit 61 constructs a model of an objective function based on the variances or standard deviations between the weighted decay curve and the parametric function of its fitted curve at a plurality of historical time points.

For example, the construction unit 61 calculates a sum of the variances or standard deviations between the weighted decay curve and the parametric function of its fitted curve at the plurality of historical time points to construct a model of an objective function.

In some embodiments, the construction unit 61 determines the weights corresponding to the plurality of historical time points based on the statistical characteristics of the function of the decay curve; constructs a model of the objective function based on the weights corresponding to the plurality of historical time points.

For example, the construction unit 61 determines the weights of the plurality of historical time points based on the minimum and average function values of the decay curve and the function values of the decay curve at the plurality of historical time points.

For example, the construction unit 61 determines the weights of the plurality of historical time points based on the differences between the function values of the decay curve at the plurality of historical time points and the minimum function value of the decay curve, and the sum of the minimum function value of the decay curve and the average function value of the decay curve, the weights of the plurality of historical time points being positively correlated with the differences and negatively correlated with the sum.

For example, the construction unit 61 determines the weights of the plurality of historical time points based on the ratios of the differences at the plurality of historical time points to the sum.

In some embodiments, the weights corresponding to the plurality of historical time points are independent of the characteristic of the decay curve. For example, the construction unit 61 determines the weights of the plurality of historical time points based on an exponential function or linear function which decreases over time; constructs a model of an objective function based on the weights of the plurality of historical time points.

In some embodiments, the construction unit 61 determines the weights corresponding to the plurality of historical time points based on the characteristics of the sound signal; constructs a model of the objective function based on the weights corresponding to the plurality of historical time points.

In some embodiments, the determination unit 62 determines a first extremum equation based on a partial derivative of the objective function with respect to a slope coefficient of a linear function; determines a second extremum equation based on a partial derivative of the objective function with respect to an intercept coefficient of the linear function; solves the first and second extremum equations to determine a slope coefficient of the fitted curve.

In some embodiments, the estimation unit 63 determines the reverberation time based on the slope coefficient of the linear function. For example, the reverberation time is proportional to the reciprocal of the slope coefficient of the linear function.

In some embodiments, the estimation unit 63 determines the reverberation time based on the slope coefficient of the linear function and a preset reverberation energy decay value. For example, the estimation unit 63 determines the reverberation time based on a ratio of the preset reverberation energy decay value to the slope coefficient. The preset reverberation energy decay value may be 60 dB.

FIG. 4d shows a block diagram of an audio signal rendering apparatus according to some embodiments of the present disclosure.

As shown in FIG. 4d, the audio signal rendering apparatus 7 comprises: the reverberation time estimation apparatus 71 described in any of the above embodiments, for determining a reverberation time of an audio signal using the reverberation time estimation method described in any of the above embodiments; a rendering unit 72 for rendering the audio signal based on the reverberation time of the audio signal.

In some embodiments, the rendering unit 72 generates a reverberation for the audio signal based on the reverberation time; adds the reverberation to a bitstream of the audio signal. For example, the rendering unit 72 generates the reverberation based on at least one of a type of an acoustic environment model or an estimated late reverberation gain.

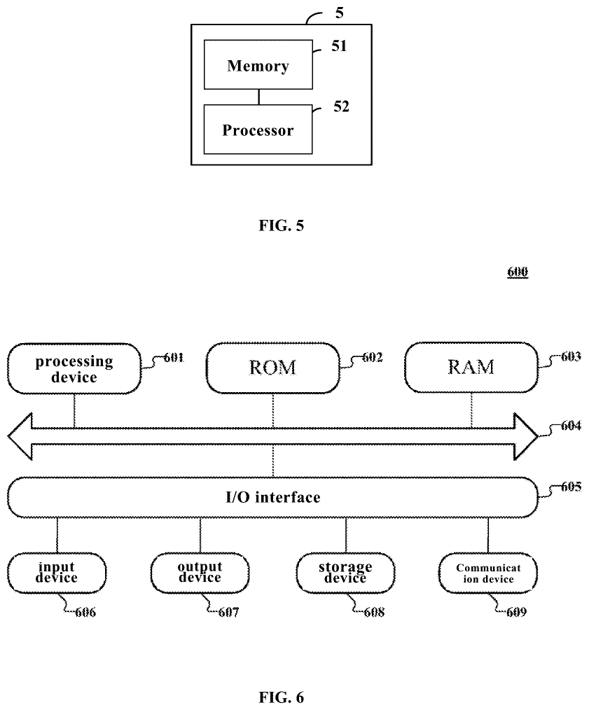

FIG. 5 shows a block diagram of an electronic device according to some embodiments of the present disclosure.

As shown in FIG. 5, the electronic device 5 of this embodiment comprises: a memory 51 and a processor 52 coupled to the memory 51, the processor 52 configured to, based on instructions stored in the memory 51, carry out the reverberation time estimation method or the audio signal rendering method described in any of the embodiments of the present disclosure.

Wherein, the memory 51 may comprise, for example, system memory, a fixed non-volatile storage medium, or the like. The system memory stores, for example, an operating system, applications, a boot loader, a database, and other programs.

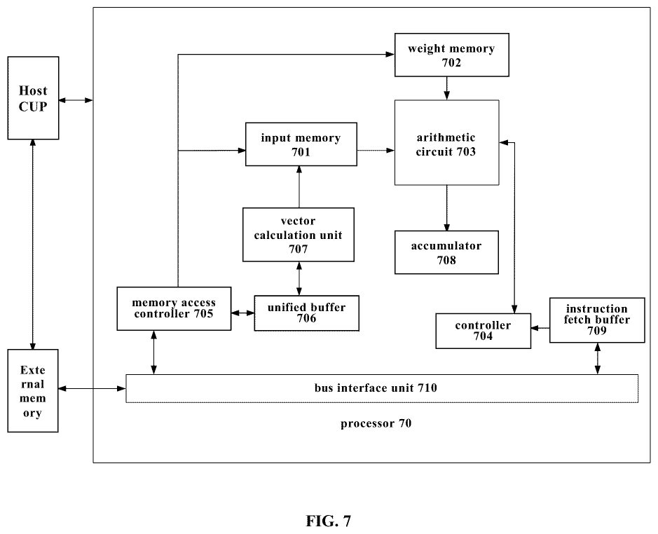

Referring now to FIG. 6, a structural diagram of an electronic device suitable for implementing the embodiments of the present disclosure is shown. The electronic device of the embodiment of the present disclosure may comprise, but not limited to, a mobile terminal such as a mobile phone, a notebook computer, a digital broadcast receiver, a PDA (Personal Digital Assistant), a PAD (tablet computer), a PMP (Portable Multimedia Player), an on-board terminal (such as an on-board navigation terminal), and a fixed terminal such as a digital TV, a desktop computer, and the like. The electronic device shown in FIG. 6 is merely an example and should not impose any limitation on the function and scope of the embodiments of the present disclosure.

FIG. 6 shows a block diagram of an electronic device according to other embodiments of the present disclosure.

As shown in FIG. 6, the electronic device may comprise a processing device (e.g., a central processing unit, a graphics processor) 601, which may perform various appropriate actions and processes according to a program stored in Read Only Memory (ROM) 602 or a program loaded from storage device 608 into Random Access Memory (RAM) 603. In RAM 603, various programs and data required for the operation of the electronic device 600 are also stored. Processing device 601, ROM 602 and RAM 603 are connected to each other through bus 604. An input/output (I/O) interface 605 is also connected to the bus 604.

Generally, the following devices can be connected to I/O interface 605: input devices 606 comprising, for example, a touch screen, a touch pad, a keyboard, a mouse, an image sensor, a microphone, an accelerometer, a gyroscope, etc; output devices 607 comprising a liquid crystal display (LCD), a speaker, a vibrator, etc.; a storage device 608 such as a magnetic tape, a hard disk, etc; and a communication device 609. The communication device 609 enables the electronic device 600 to communicate with other devices to exchange data in a wired or wireless manner. Although FIG. 6 shows the electronic device with various components, it should be understood that it is not required to implement or have all of these components. Alternatively, more or fewer components can be implemented or provided.

According to an embodiment of the present disclosure, the processes described above with reference to the flowchart can be implemented as a computer software program. For example, some embodiments of the present disclosure comprise a computer program product comprising a computer program carried on a computer-readable medium, the computer program containing program code for performing the method illustrated in the flowcharts. In such an embodiment, the computer program may be downloaded and installed from the network through the communication device 609, or installed from the storage device 608, or from the ROM 602. When the computer program is executed by the processing device 601, the above functions defined in the method of the embodiment of the present disclosure are performed.

In some embodiments, there is further provided a chip, comprising: at least one processor, and an interface for providing computer executable instructions to the at least one processor, wherein the at least one processor is used to execute the computer executable instructions to implement the reverberation time estimation method or the audio signal rendering method according to any of the above embodiments.

FIG. 7 shows a block diagram of a chip according to some embodiments of the present disclosure.

As shown in FIG. 7, processor 70 of the chip is mounted as a coprocessor on the host CPU, with its tasks being allocated by the host CPU. The core part of processor 70 is an arithmetic circuit, and controller 704 controls the arithmetic circuit 703 to extract data from memory (weight memory or input memory) and perform operations.

In some embodiments, the arithmetic circuit 703 comprises multiple processing units (PE) internally. In some embodiments, the arithmetic circuit 703 is a two-dimensional systolic array. The arithmetic circuit 703 can also be a one-dimensional systolic array or other electronic circuits capable of performing mathematical operations such as multiplication and addition. In some embodiments, the arithmetic circuit 703 is a general-purpose matrix processor.

For example, suppose there is an input matrix A, a weight matrix B, and an output matrix C, the arithmetic circuit fetches data of matrix B from the weight memory 702 and catches the data on each PE of the arithmetic circuit. The arithmetic circuit fetches data of matrix A from the input memory 701 and performs matrix operations on the data of matrices A and B. The intermediate or final result of the matrix obtained is stored in the accumulator 708.

The vector calculation unit 707 can perform further operations on the output of the arithmetic circuit, such as vector multiplication, vector addition, exponential operation, logarithmic operation, size comparison, etc.

In some embodiments, the vector calculation unit 707 store the processed output vectors in unified buffer 706. For example, the vector calculation unit 707 can apply nonlinear functions to the output of the arithmetic circuit 703, such as a vector of accumulated values, to generate activation values. In some embodiments, the vector calculation unit 707 generates normalized values, combined values, or both. In some embodiments, the processed output vector can be used as an activation input to the arithmetic circuit 703, for example, for use in subsequent layers in neural networks.

The unified buffer 706 is used to store input data and output data.

The memory access controller 705 (DMAC) transfers input data from external memory to input memory 701 and/or unified buffer 706, stores weight data from external memory in weight memory 702, and stores data from unified buffer 706 in external memory.

Bus Interface Unit (BIU) 510 is used for the interaction between the host CPU, the DMAC, and instruction memory 709 through the bus.

The instruction fetch buffer 709 connected to controller 704 is used to store instructions used by the controller 704;

Controller 704 is used to call instructions cached in memory 709 and control the operation process of the operation accelerator.

Generally, the unified buffer 706, input memory 701, weight memory 702, and instruction memory 709 are all On Chip memory, and the external memory is memory external to the NPU. The external memory can be Double Data Rate Synchronous Dynamic Random Access Memory (DDR SDRAM)), High Bandwidth Memory (HBM), or other readable and writable memory.

In some embodiments, there is further provided a computer program product, comprising: instructions that, when executed by a processor, cause the processor to perform the reverberation time estimation method or the audio signal rendering method according to any of the above embodiments.

According to still further embodiments of the present disclosure, there is provided a computer program comprising instructions that, when executed by a processor, implement the reverberation time estimation method or the audio signal rendering method according to any of the above embodiments.

According to other embodiments of the present disclosure, there is provided an audio signal rendering method, comprising: estimating a reverberation time of an audio signal at each of a plurality of time points; rendering the audio signal based on the reverberation time of the audio signal.

In some embodiments, rendering the audio signal comprises: generating a reverberation for the audio signal based on the reverberation time, wherein the reverberation is added to a bitstream of the audio signal.

In some embodiments, generating a reverberation for the audio signal comprises: generating the reverberation based on at least one of a type of an acoustic environment model or an estimated late reverberation gain.

In some embodiments, estimating a reverberation time of an audio signal comprises: constructing a model of an objective function based on a decay curve of the audio signal, a parametric function of a fitted curve of the decay curve, and weights corresponding to a plurality of historical time points, wherein the weights vary with time; solving the objective function with a parameter of the parametric function of the fitted curve as a variable and an objective of minimizing the model of the objective function to determine the fitted curve of the decay curve; estimating a reverberation time of the audio signal based on the fitted curve.

In some embodiments, constructing a model of an objective function comprises: constructing the model of the objective function based on differences between the decay curve and the parametric function of the fitted curve of the decay curve at the plurality of historical time points, and the weights corresponding to the plurality of historical time points.

In some embodiments, a weight corresponding to a later time point is smaller than a weight corresponding to an earlier time point.

In some embodiments, constructing the model of the objective function comprises: calculating a weighted sum of the differences between the decay curve and the parametric function of the fitted curve at the plurality of historical time points using the weights corresponding to the plurality of historical time points; constructs a model of the objective function based on the weighted sum of the differences between the decay curve and the parametric function of the fitted curve at the plurality of historical time points.

In some embodiments, calculating a weighted sum of the differences between the decay curve and the parametric function of the fitted curve at the plurality of historical time points using the weights corresponding to the plurality of historical time points comprises: calculating a weighted sum of variances or standard deviations between the decay curve and the parametric function of the fitted curve at the plurality of historical time points using the weights corresponding to the plurality of historical time points.

In some embodiments, constructing the model of the objective function comprises: weighting the decay curve at the plurality of historical time points using the weights corresponding to the plurality of historical time points; constructing the model of the objective function based on differences between the weighted decay curve and the parametric function of the fitted curve at the plurality of historical time points.

In some embodiments, constructing the model of the objective function comprises: calculating a sum of differences between the weighted decay curve and the parametric function of the fitted curve at the plurality of historical time points to construct the model of the objective function.

In some embodiments, constructing the model of the objective function comprises: constructing the model of the objective function based on variances or standard deviations between the weighted decay curve and the parametric function of the fitted curve at the plurality of historical time points.

In some embodiments, constructing the model of the objective function comprises: calculating a sum of the variances or standard deviations between the weighted decay curve and the parametric function of the fitted curve at the plurality of historical time points to construct the model of the objective function.

In some embodiments, constructing the model of the objective function comprises: determining weights corresponding to the plurality of historical time points based on a statistical characteristic of the parametric function of the decay curve; constructing the model of the objective function based on the weights corresponding to the plurality of historical time points.

In some embodiments, determining weights corresponding to the plurality of historical time points comprises: determining the weights of the plurality of historical time points based on a minimum value and average value of the parametric function of the decay curve and values of the parametric function of the decay curve at the plurality of historical time points.

In some embodiments, determining weights corresponding to the plurality of historical time points comprises: determining the weights of the plurality of historical time points based on the differences between the function values of the parametric function of the decay curve at the plurality of historical time points and the minimum value of the parametric function of the decay curve, and a sum of the minimum value of the parametric function of the decay curve and the average value of the parametric function of the decay curve, the weights of the plurality of historical time points being positively correlated with the differences and negatively correlated with the sum.

In some embodiments, determining weights corresponding to the plurality of historical time points comprises: determining the weights of the plurality of historical time points based on ratios of the differences at the plurality of historical time points to the sum.

In some embodiments, the weights corresponding to the plurality of historical time points are independent of the characteristic of the decay curve.

In some embodiments, constructing the model of the objective function comprises: determining weights corresponding to the plurality of historical time points based on a characteristic of the sound signal; constructing the model of the objective function based on the weights corresponding to the plurality of historical time points.

In some embodiments, constructing the model of the objective function comprises: determining the weights of the plurality of historical time points based on an exponential function or linear function which decreases over time; constructing the model of the objective function based on the weights of the plurality of historical time points.

In some embodiments, the parametric function of the fitted curve is a linear function with time as a variable, and estimating a reverberation time of the audio signal based on the fitted curve comprises: determining the reverberation time based on a slope coefficient of the linear function.

According to still other embodiments of the present disclosure, there is provided an audio signal rendering apparatus, comprising: an estimation apparatus for estimating the reverberation time of the audio signal at each of a plurality of time points; a rendering unit for rendering the audio signal based on the reverberation time of the audio signal.

In some embodiments, the estimation apparatus comprises: a construction unit for constructing a model of an objective function based on a decay curve of the audio signal, a parametric function of a fitted curve of the decay curve, and weights corresponding to a plurality of historical time points, wherein the weights vary with time; a determination unit for determining the fitted curve of the decay curve by solving the objective function with a parameter of the parametric function of the fitted curve as a variable and an objective of minimizing the model of the objective function; an estimation unit for estimating a reverberation time of the audio signal based on the fitted curve.

Those skilled in the art should understand that embodiments of the present disclosure can take the form of an entirely hardware embodiment, an entirely software embodiment or an embodiment containing both hardware and software elements. When implemented in software, the above embodiment can be implemented in whole or in part in the form of a computer program product. The computer program product comprises one or more computer instructions or computer programs. The computer instructions or computer programs, when loaded and executed on a computer, can generate in whole or in part the processes or functions according to embodiments of the present disclosure. The computer may be a general purpose computer, a special purpose computer, a computer network, or other programmable device. Moreover, the present disclosure may take the form of a computer program product embodied on one or more computer-usable non-transitory storage media (comprising but not limited to disk storage, CD-ROM, optical storage device, etc.) having computer-usable program code embodied therein.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. An audio signal rendering method, comprising:
estimating a reverberation time of an audio signal at each of a plurality of time points; and
rendering the audio signal based on the reverberation time of the audio signal.

2. The rendering method according to claim 1, wherein the rendering the audio signal comprises:
generating a reverberation for the audio signal based on the reverberation time, wherein the reverberation is added to a bitstream of the audio signal.

3. The rendering method according to claim 2, wherein the generating the reverberation for the audio signal comprises:
generating the reverberation based on at least one of a type of an acoustic environment model or an estimated late reverberation gain.

4. The rendering method according to claim 1, wherein the estimating the reverberation time of the audio signal comprises:
constructing a model of an objective function based on a decay curve of the audio signal, a parametric function of a fitted curve of the decay curve, and weights corresponding to a plurality of historical time points, wherein the weights vary with time;
solving the objective function with a parameter of the parametric function of the fitted curve as a variable and an objective of minimizing the model of the objective function to determine the fitted curve of the decay curve; and
estimating a reverberation time of the audio signal based on the fitted curve.

5. The rendering method according to claim 4, wherein the constructing the model of the objective function comprises:
constructing the model of the objective function based on differences between the decay curve and the parametric function of the fitted curve of the decay curve at the plurality of historical time points, and the weights corresponding to the plurality of historical time points; or
weighting the decay curve at the plurality of historical time points using the weights corresponding to the plurality of historical time points; and constructing the model of the objective function based on differences between the weighted decay curve and the parametric function of the fitted curve at the plurality of historical time points.

6. The estimation method according to claim 4, wherein: a weight corresponding to a later time point is smaller than a weight corresponding to an earlier time point; or the weights corresponding to the plurality of historical time points are independent of the characteristic of the decay curve.

7. The estimation method according to claim 5, wherein the constructing the model of the objective function comprises:
calculating a weighted sum of the differences between the decay curve and the parametric function of the fitted curve at the plurality of historical time points using the weights corresponding to the plurality of historical time points; and
constructing the model of the objective function based on the weighted sum of the differences between the decay curve and the parametric function of the fitted curve at the plurality of historical time points.

8. The estimation method according to claim 7, wherein the calculating the weighted sum of the differences between the decay curve and the parametric function of the fitted curve at the plurality of historical time points using the weights corresponding to the plurality of historical time points comprises:
calculating the weighted sum of variances or standard deviations between the decay curve and the parametric function of the fitted curve at the plurality of historical time points using the weights corresponding to the plurality of historical time points.

9. The estimation method according to claim 5, wherein the constructing the model of the objective function comprises:
calculating a sum of differences between the weighted decay curve and the parametric function of the fitted curve at the plurality of historical time points to construct the model of the objective function; or
constructing the model of the objective function based on variances or standard deviations between the weighted decay curve and the parametric function of the fitted curve at the plurality of historical time points.

10. The estimation method according to claim 9, wherein the constructing the model of the objective function comprises:
calculating a sum of the variances or standard deviations between the weighted decay curve and the parametric function of the fitted curve at the plurality of historical time points to construct the model of the objective function.

11. The estimation method according to claim 4, wherein the constructing the model of the objective function comprises:
determining weights corresponding to the plurality of historical time points based on a statistical characteristic of the parametric function of the decay curve; and constructing the model of the objective function based on the weights corresponding to the plurality of historical time points; or
determining the weights corresponding to the plurality of historical time points based on a characteristic of the sound signal; and constructing the model of the objective function based on the weights corresponding to the plurality of historical time points.

12. The estimation method according to claim 11, wherein the constructing determining the weights of the plurality of historical time points comprises:
determining the weights of the plurality of historical time points based on a minimum value and average value of the parametric function of the decay curve and values of the parametric function of the decay curve at the plurality of historical time points.

13. The estimation method according to claim 12, wherein the constructing determining the weights of the plurality of historical time points comprises:
determining the weights of the plurality of historical time points based on differences between the function values of the parametric function of the decay curve at the plurality of historical time points and the minimum value of the parametric function of the decay curve, and a sum of the minimum value of the parametric function of the decay curve and the average value of the parametric function of the decay curve, the weights of the plurality of historical time points being positively correlated with the differences and negatively correlated with the sum.

14. The estimation method according to claim 13, wherein the determining the weights of the plurality of historical time points comprises:
determining the weights of the plurality of historical time points based on ratios of the differences to the sum at the plurality of historical time points.

15. The estimation method according to claim 4, wherein the parametric function of the fitted curve is a linear function with time as a variable, and the estimating the reverberation time of the audio signal based on the fitted curve comprises:
determining the reverberation time based on a slope coefficient of the linear function; or
wherein the decay curve is determined based on a Room Impulse Response (RIR) of the audio signal.

16. The estimation method according to claim 15, wherein the reverberation time is proportional to a reciprocal of the slope coefficient of the linear function.

17. The estimation method according to claim 15, wherein:
the determining the reverberation time based on the slope coefficient of the linear function comprises: determining the reverberation time based on the slope coefficient of the linear function and a preset reverberation energy decay value; or
the determining the fitted curve of the decay curve comprises:
determining a first extremum equation based on a partial derivative of the objective function with respect to the slope coefficient of the linear function;
determining a second extremum equation based on a partial derivative of the objective function with respect to an intercept coefficient of the linear function; and
solving the first extremum equation and the second extremum equation to determine the slope coefficient of the parametric function of the fitted curve.

18. A chip, comprising:
at least one processor, and an interface for providing computer executable instructions to the at least one processor, wherein the at least one processor is used to execute the computer executable instructions to implement an audio signal rendering method according to claim 1.

19. an electronic device, comprising:
a memory; and
a processor coupled to the memory, the processor configured to, based on instructions stored in the memory, carry out an audio signal rendering method, comprising:
estimating a reverberation time of an audio signal at each of a plurality of time points; and
rendering the audio signal based on the reverberation time of the audio signal.

20. A non-transitory computer-readable storage medium on which a computer program is stored, the program when executed by a processor implementing an audio signal rendering method, comprising:
estimating a reverberation time of an audio signal at each of a plurality of time points; and
rendering the audio signal based on the reverberation time of the audio signal.
